(19) United States
(12) Patent Application Publication
(10) Pub. No.: US 2025/0337641 A1
(43) Pub. Date: Oct. 30, 2025

(54) SERVICE PROVISIONING ANOMALY DETECTION IN WIRELESS COMMUNICATION NETWORKS

(71) Applicant: T-MOBILE INNOVATIONS LLC, Overland Park, KS (US)

(72) Inventors: Shrustishree Sumanth, Bothell, WA (US); Henry Pradeep Kumar Cyril, Bothell, WA (US)

(21) Appl. No.: 18/650,746

(22) Filed: Apr. 30, 2024

(51) Int. Cl. H04L 41/0806; H04L 41/16; H04W 8/18

(52) U.S. Cl. CPC H04L 41/0806; H04L 41/16; H04W 8/183

(57) ABSTRACT

Various embodiments include a wireless communication network that comprises provisioning circuitry. The provisioning circuitry converts customer facing services to network service attributes that define service provided to a user device on the network. The provisioning circuitry transfers a command to a network element to update existing service attributes stored in the device's subscriber profile using the network service attributes. The provisioning circuitry queries the network element to retrieve implemented service attributes from the subscriber profile. The provisioning circuitry provides the customer facing services, the network service attributes, and the implemented service attributes to a machine learning model trained to detect discrepancies between implemented service attributes and customer facing services. In response to detecting a discrepancy between the customer facing services and the implemented service attributes, the provisioning circuitry transfers an update to the network element to correct the discrepancy between the implemented service attributes and the customer facing services.

### TECHNICAL FIELD

Various embodiments of the present technology relate to provisioning, and more specifically, to detecting service discrepancies during service attribute provisioning.

### BACKGROUND

Wireless communication networks provide wireless data services to wireless user devices. Exemplary wireless data services include voice calling, video calling, internet-access, media-streaming, online gaming, social-networking, and machine-control. Exemplary wireless user devices comprise phones, computers, vehicles, robots, and sensors. Radio Access Networks (RANs) exchange wireless signals with the wireless user devices over radio frequency bands. The wireless signals use wireless network protocols like Fifth Generation New Radio (5GNR), Long Term Evolution (LTE), Institute of Electrical and Electronic Engineers (IEEE) 802.11 (WIFI), and Low-Power Wide Area Network (LP-WAN). The RANs exchange network signaling and user data with network elements that are often clustered together into wireless network cores over backhaul data links. The core networks execute network functions to provide wireless data services to the wireless user devices. Exemplary network functions include Access and Mobility Management Function (AMF), Policy Control Function (PCF), Unified Data Management (UDM), and Unified Data Registry (UDR).

Service provisioning relates to enabling customer services in wireless communication networks. The network provisioning engine is a network entity responsible for service provisioning. The provisioning engine receives a subscription request for a user device from a billing system. The subscription request comprises service descriptors that characterize the user device's subscription on the wireless network. For example, the service descriptors may indicate the user device is subscribed for domestic voice calling and domestic data service. The provisioning engine converts the service descriptors into network attributes interpretable by the network functions in the core network to enable service for the user device. Due to the large number of network functions and operations in the core network, a single service descriptor corresponds to a large number of network attributes. The one-to-many relationship between customer facing service descriptors and network attributes increases the difficulty of provisioning the user device. The difficulty is compounded by the large number (e.g., up to 1,000,000 per day) of provisioning transactions processed by the provisioning engine. The difficult provisioning process results in provisioning errors which disable services the user device is subscribed for or provide non-subscribed services to the user device.

Unfortunately, in some instances, wireless communication networks may not efficiently detect provisioning errors. Moreover, some wireless communication networks may not always effectively respond to provisioning errors.

### Overview

This Overview is provided to introduce a selection of concepts in a simplified form that are further described below in the Technical Description. This summary is not intended to identify key features or essential features of the claimed subject matter, nor is it intended to be used as an aid in determining the scope of the claimed subject matter.

Various embodiments of the present technology relate to solutions for wireless network provisioning. Some embodiments comprise a method. The method comprises in a provisioning system of a wireless communication network, converting customer facing services to network service attributes, wherein the network service attributes define service provided to a user device by network elements of the wireless communication network. The method further comprises the provisioning system transferring a provisioning command to at least one of the network elements to update existing service attributes stored in a subscriber profile of the user device using the network service attributes. The method further comprises the provisioning system querying the one of the network elements to retrieve implemented service attributes associated with the user device from the subscriber profile. The method further comprises the provisioning system providing the customer facing services, the network service attributes, and the implemented service attributes to a machine learning model trained to detect discrepancies between the implemented service attributes and the customer facing services associated with the user device. The method further comprises the provisioning system, in response to the machine learning model detecting a discrepancy between the customer facing services and the implemented service attributes, transferring a provisioning update to the one of the network elements to correct the discrepancy between the implemented service attributes and the customer facing services.

Some embodiments comprise a wireless communication network. The wireless communication network comprises network provisioning circuitry. The network provisioning circuitry converts customer facing services to network service attributes, wherein the network service attributes define service provided to a user device by network elements of the wireless communication network. The network provisioning circuitry transfers a provisioning command to at least one of the network elements to update existing service attributes stored in a subscriber profile of the user device using the network service attributes. The network provisioning circuitry queries the one of the network elements to retrieve implemented service attributes associated with the user device from the subscriber profile. The network provisioning circuitry provides the customer facing services, the network service attributes, and the implemented service attributes to a machine learning model trained to detect discrepancies between the implemented service attributes and the customer facing services associated with the user device. In response to the machine learning model detecting a discrepancy between the customer facing services and the implemented service attributes, the network provisioning circuitry transfers a provisioning update to the one of the network elements to correct the discrepancy between the implemented service attributes and the customer facing services.

Some embodiments comprise one or more non-transitory computer-readable storage media having program instructions stored thereon. When executed by a computing system, the program instructions direct the computing system to perform operations. The operations comprise in a provisioning system of a wireless communication network, converting customer facing services to network service attributes, wherein the network service attributes define service provided to a user device by network elements of the wireless communication network. The operations further comprise transferring a provisioning command to at least one of the network elements to update existing service attributes stored in a subscriber profile of the user device using the network service attributes. The operations further comprise querying the one of the network elements to retrieve implemented service attributes associated with the user device from the subscriber profile. The operations further comprise providing the customer facing services, the network service attributes, and the implemented service attributes to a machine learning model trained to detect discrepancies between the implemented service attributes and the customer facing services associated with the user device. The operations further comprise, in response to the machine learning model detecting a discrepancy between the customer facing services and the implemented service attributes, transferring a provisioning update to the one of the network elements to correct the discrepancy between the implemented service attributes and the customer facing services.

### DESCRIPTION OF THE DRAWINGS

Many aspects of the disclosure can be better understood with reference to the following drawings. The components in the drawings are not necessarily drawn to scale. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 illustrates a communication network.

FIG. 2 illustrates an exemplary operation of the communication network.

FIG. 3 illustrates a wireless communication network.

FIG. 4 illustrates an exemplary operation of the wireless communication network.

FIG. 5 illustrates an exemplary operation of the wireless communication network.

FIG. 6 illustrates a Fifth Generation (5G) wireless communication network.

FIG. 7 illustrates network functions and a provisioning system in the 5G wireless communication network.

FIG. 8 illustrates a Network Function Virtualization Infrastructure (NFVI) and provisioning system in the 5G wireless communication network.

FIG. 9 further illustrates the NFVI and provisioning system in the 5G wireless communication network.

FIG. 10 illustrates an exemplary operation of the 5G wireless communication network to detect provisioning anomalies.

The drawings have not necessarily been drawn to scale. Similarly, some components or operations may not be separated into different blocks or combined into a single block for the purposes of discussion of some of the embodiments of the present technology. Moreover, while the technology is amendable to various modifications and alternative forms, specific embodiments have been shown by way of example in the drawings and are described in detail below. The intention, however, is not to limit the technology to the particular embodiments described. On the contrary, the technology is intended to cover all modifications, equivalents, and alternatives falling within the scope of the technology as defined by the appended claims.

### Technical Description

The following description and associated figures teach the best mode of the invention. For the purpose of teaching inventive principles, some conventional aspects of the best mode may be simplified or omitted. The following claims specify the scope of the invention. Note that some aspects of the best mode may not fall within the scope of the invention as specified by the claims. Thus, those skilled in the art will appreciate variations from the best mode that fall within the scope of the invention. Those skilled in the art will appreciate that the features described below can be combined in various ways to form multiple variations of the invention. As a result, the invention is not limited to the specific examples described below, but only by the claims and their equivalents.

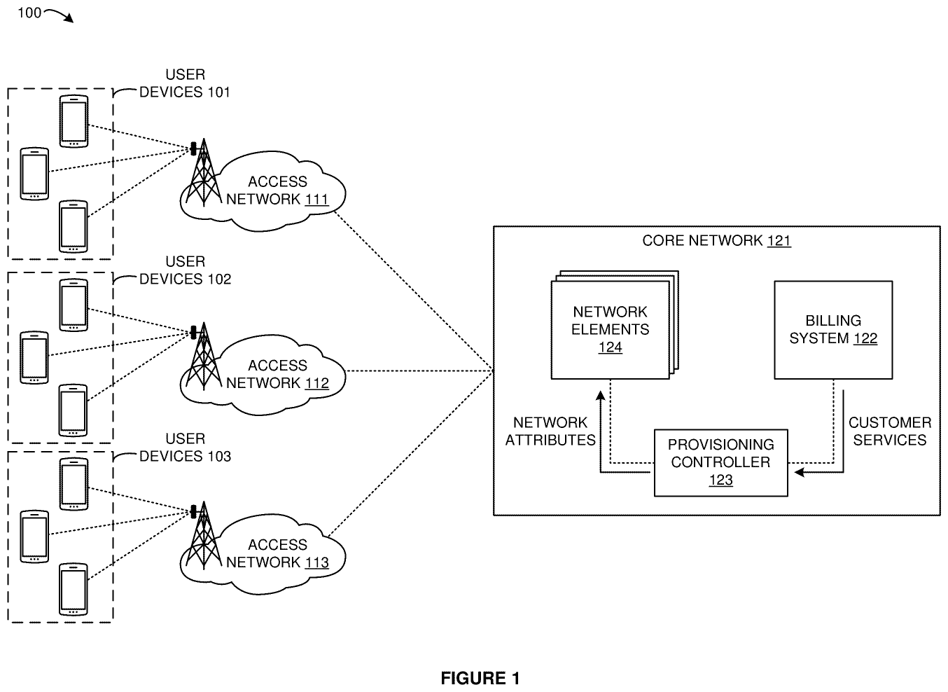

FIG. 1 illustrates communication network 100 to detect provisioning anomalies. Communication network 100 delivers services like voice calling, machine communications, internet-access, media-streaming, or some other wireless/wireline communications product to user devices. Communication network 100 comprises user devices 101-103, access networks 111-113, and core network 121. Core network 121 comprises billing system 122, provisioning controller 123, and network elements 124. In other examples, communication network 100 may comprise additional or different elements than those illustrated in FIG. 1.

Various examples of network operation and configuration are described herein. In some examples, core network 121 provides wireless services to user devices 101-103 over access networks 111-113. Core network 121 serves devices 101 over access network 111. Core network 121 serves devices 102 over access network 112. Core network 121 serves devices 103 over access network 113. Billing system 122 receives a service update for a user device (e.g., one of the devices in user device 102). Exemplary services include voice calling, international voice, domestic/international roaming, call forwarding, call waiting capability, Short-Message-Service (SMS), Multimedia Messaging Service (MMS), Rich Communication Service (RCS), domestic data service, data hotspot, roaming data service, voicemail, static Internet Protocol (IP) address management, Wi-Fi calling, scam protection, value added services, and the like. Service updates are customer requests to activate services, add services, deactivate services, and the like. Billing system 122 transfers the requested customer services to provisioning controller 123.

Provisioning controller 123 is a network entity responsible for translating customer services into network service attributes and providing the network service attributes to ones of network elements 124 to enable the services to the user device. Provisioning controller 123 translates the customer services into network attributes interpretable by network elements 124. Provisioning controller 123 transfers the resulting network attributes to network elements 124. For example, provisioning controller 123 may receive customer service code selecting domestic voice calling (e.g., VOICE_MO_NAT). Provisioning controller 123 may then translate customer service code into key value pairs interpretable by network elements 124 to enable domestic voice calling for the user device over access networks 111-113.

Network elements 124 are representative of network functions, network entities, network data systems, subscriber profiles, and/or other network systems responsible for serving user devices 101-103. Network elements 124 receive the service attributes from provisioning controller 123. Network elements 124 update existing service attributes using the received service attributes to update service to the associated user device. Once the update has been processed, provisioning controller 123 queries network elements 124 to report the service attributes for the user device. Network elements 124 report the service attributes that they actually implemented for the user device. Provisioning controller 123 compares the actually implemented service attributes to the customer services received from billing system 122 and the attributes it transferred to the network elements 124 to detect discrepancies between the intended services to the user device and the actual service to the user device. When provisioning controller 123 detects a discrepancy, controller 123 transfers a provisioning update to network elements 124 to correct the discrepancy.

User devices 101-103 are representative of wireless/wireline user devices. Exemplary user devices include phones, smartphones, computers, vehicles, drones, robots, sensors, and/or other devices with wireless communication capabilities. Access networks 111-113 exchange wireless signals with user devices 101-103 over radio frequency bands. The radio frequency bands use wireless network protocols like Fifth Generation New Radio (5GNR), Long Term Evolution (LTE), Institute of Electrical and Electronic Engineers (IEEE) 802.11 (WIFI), and Low-Power Wide Area Network (LP-WAN). Access networks 111-113 are connected to core network 121 over backhaul data links. Access networks 111-113 exchange network signaling and user data with network elements 124 in core network 121.

Access networks 111-113 may comprise wireless access nodes, internet backbone providers, edge computing systems, or other types of wireless/wireline access systems to provide communication links to user devices 101-103, the backhaul links to core network 121, and the edge computing services between user devices 101-103 and core network 121. Although access networks 111-113 are illustrated comprising towers, access networks 111-113 may comprise other types of mounting structures (e.g., buildings), or no mounting structure at all. Access networks 111-113 may comprise Fifth Generation (5G) RANs, LTE RANs, gNodeBs, eNodeBs, NB-IoT access nodes, LP-WAN base stations, wireless relays, WIFI hotspots, Bluetooth access nodes, and/or other types of wireless or wireline network transceivers. Access networks 111-113 may comprise a Radio Unit (RU), Distributed Unit (DU), and Centralized Unit (CU) architecture. The RUs may be mounted at elevation and have antennas, modulators, signal processors, and the like. The RUs are connected to the DUs which are usually nearby network computers. The DUs handle lower wireless network layers like the Physical Layer (PHY), Media Access Control (MAC), and Radio Link Control (RLC). The DUs are connected to the CUs which are larger computer centers that are closer to core network 121. The CUs handle higher wireless network layers like the Radio Resource Control (RRC), Service Data Adaption Protocol (SDAP), and Packet Data Convergence Protocol (PDCP). The CUs are coupled to network functions in core network 121.

Core network 121 is representative of computing systems that provide wireless data services to user devices 101-103 over access networks 111-113. Exemplary computing systems comprise data centers, server farms, Network Function Virtualization Infrastructure (NFVI), cloud computing networks, hybrid cloud networks, and the like. The computing systems of core network 121 store and execute the network functions to form billing system 122, provisioning controller 123, and network elements 124 to provide wireless data services to user devices 101-103 over access networks 111-113. Billing system 122 comprises network entities like Customer Relations Management (CRM) server, and the like. Provisioning controller 123 comprises network functions like provisioning engines, anomaly detection engines, provisioning catalogs, and the like. Network elements 124 comprise network entities like Unified Data Management (UDM), Policy Control Function (PCF), Short Message Service Function (SMFS), Charging Function (CHF), Unified Data Registry (UDR), Home Subscriber Server (HSS), Home Subscriber Register (HLR), and the like. The computing systems of core network 121 typically store and execute other network functions to form a control plane (not illustrated) and a user plane (not illustrated) to serve user devices 101-103. The control plane typically comprises network functions like Access and Mobility Management Function (AMF), Session Management Function (SMF), and the like. The user plane typically comprises network functions like User Plane Function (UPF) and the like. Core network 121 may comprise a Third Generation Partnership Project (3GPP) core architecture like Sixth Generation Core (6GC) architecture, Fifth Generation Core (5GC) architecture, an Evolved Packet Core (EPC) architecture, and the like.

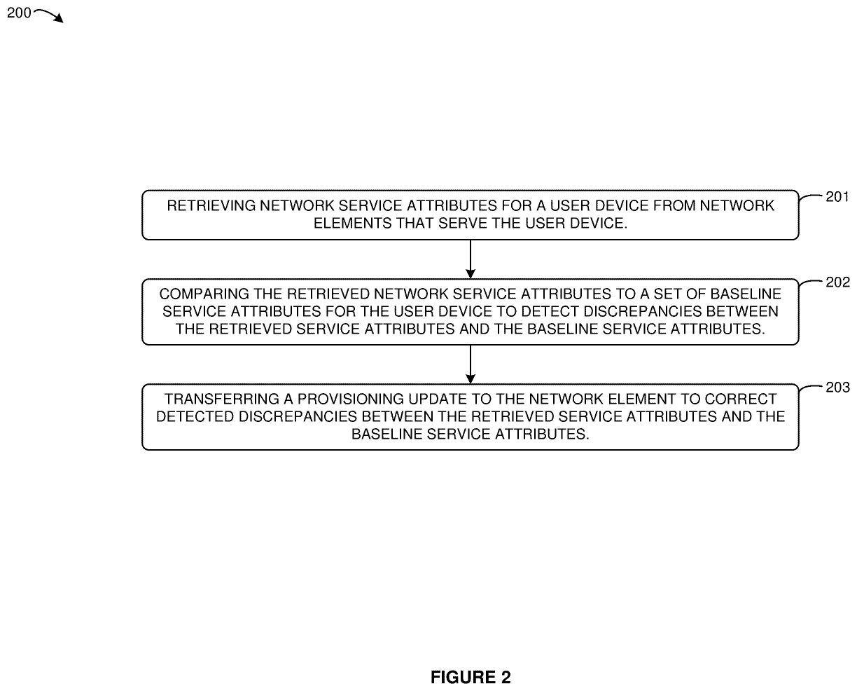

FIG. 2 illustrates process 200. Process 200 comprises an exemplary operation of communication network 100 to detect provisioning anomalies. The operation may vary in other examples. The operations of process 200 comprise retrieving network service attributes for a user device from network elements that serve the user device (step 201). The operations further comprise comparing the retrieved network service attributes to a set of baseline service attributes for the user device to detect discrepancies between the retrieved service attributes and the baseline service attributes (step 202). The operations further comprise transferring a provisioning update to the network element to correct detected discrepancies between the retrieved service attributes and the baseline service attributes (step 203).

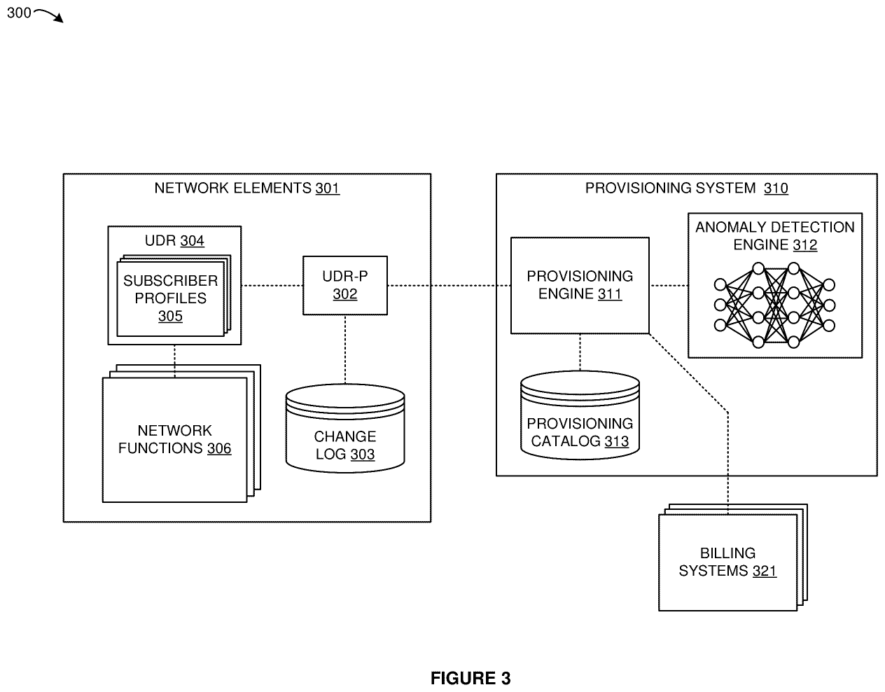

FIG. 3 illustrates wireless communication network 300 to detect provisioning anomalies. Wireless communication network 300 is an example of communication network 100, however network 100 may differ. Wireless communication network 300 comprises network elements 301, provisioning system 310, billing systems 321. Network elements 301 comprises UDR-Provisioners (UDR-Ps) 302, change log 303, UDR 304, subscriber profiles 205, and network functions 306. Provisioning system 310 comprises provisioning engine 311, anomaly detection engine 312, and provisioning catalog 313. Network functions 306 comprise 5GC and/or EPC network entities like AMF, SMF, UPF, PCF, UDM, SMSF, HSS, HLR, Session Communication Proxy (SCP), and Diameter Routing Agent (DRA). In other examples, wireless network 300 may comprise additional or different elements than those illustrated in FIG. 3.

In some examples, provisioning engine 311 receives a subscriber profile update from billing systems 321. For example, a user in network 300 may have upgraded their level of service (e.g., added international voice calling) and billing system 321 may transfer the update to engine 311 to modify the user's subscriber profile to include the upgraded service level. Engine 311 identifies the subscriber profile associated with the update based on a subscriber Identifier (ID). Exemplary subscriber IDs include International Mobile Subscriber Identity (IMSI), Subscriber Permanent Identifier (SUPI), and the like. Provisioning engine 311 accesses provisioning catalog 313 to translate customer facing service codes received from billing systems 321 into network facing service attributes interpretable by network functions 306. Provisioning engine 311 transfers a provisioning command to UDR-P 302 that directs UDR-P 302 to modify one of subscriber profiles 305 using the translated network service attributes. UDP-302 locates the corresponding subscriber profile stored on UDR 304 based on the subscriber ID and implements the provisioning update. UDR-P 302 logs the changes to the profile in change log 303 and notifies provisioning controller 311 that the update was successful.

Subsequently, provisioning engine 311 queries change log 303 to retrieve data characterizing the as-is state of the recently updated subscriber profile. In particular, provisioning engine 311 retrieves a list of active service attributes for the updated subscriber profile. For example, provisioning engine 311 may retrieve the address value pairs defining the currently authorized services, Quality-of-Service levels, and authorized data rates for the recently updated subscriber profile. Provisioning engine 311 provides the service attributes retrieved from the subscription profile, the network service attributes transferred to UDR-P 302 during the update, and the customer facing service codes received from billing systems 321 to detection engine 312. Detection engine 312 hosts a machine learning model trained to detect service discrepancies in subscriber profiles 305. Engine 312 processes the received data using its machine learning model to generate an output indicating the existence of any discrepancies as well as recommended actions to correct the discrepancy. When a discrepancy is detected, anomaly detection engine 312 notifies provisioning engine 311. Provisioning engine 311 then transfers a provisioning update to UDR-P 302 to correct the service discrepancy. UDR-P 302 writes the update to the subscriber profile stored in UDR 304. For example, provisioning engine 311 may direct UDR-P 302 to include erroneously excluded service attributes, remove erroneously included service attributes, and/or correct erroneous value in the service attributes (e.g., correcting erroneous values like incorrect QoS address value pairs, incorrect data rate address value pairs, etc.) in the subscriber profile stored by UDR 304.

Advantageously, wireless communication network 300 efficiently detects provisioning errors like under-provisioning or over-provisioning of subscribers on network 300. Moreover, wireless communication network 300 effectively responds to detected provisioning errors to inhibit interruptions caused by provisioning errors. By effectively responding to provisioning errors, network 300 improves user experience on network 300 by reducing service interruptions caused by provisioning errors.

Network elements 301, provisioning system 310, and billing systems 321 communicate over various links that use metallic links, glass fibers, radio channels, or some other communication media. The links use 3GPP links, Fifth Generation Core (5GC), Evolved Packet Core (EPC), IEEE 802.3 (ENET), Time Division Multiplex (TDM), Data Over Cable System Interface Specification (DOCSIS), Internet Protocol (IP), General Packet Radio Service Transfer Protocol (GTP), 5GNR, LTE, WIFI, virtual switching, inter-processor communication, bus interfaces, and/or some other data communication protocols. Network elements 301, provisioning system 310, and billing systems 321 comprise microprocessors, software, memories, transceivers, bus circuitry, and the like. The microprocessors comprise Digital Signal Processors (DSP), Central Processing Units (CPU), Graphical Processing Units (GPU), Application-Specific Integrated Circuits (ASIC), Field Programmable Gate Array (FPGA), and/or the like. The memories comprise Random Access Memory (RAM), flash circuitry, Solid State Drives (SSD), Non-Volatile Memory Express (NVMe) SSDs, Hard Disk Drives (HDDs), and/or the like. The memories store software like operating systems, user applications, network functions, and multimedia functions. The microprocessors retrieve the software from the memories and execute the software to drive the operation of wireless communication network 300 as described herein.

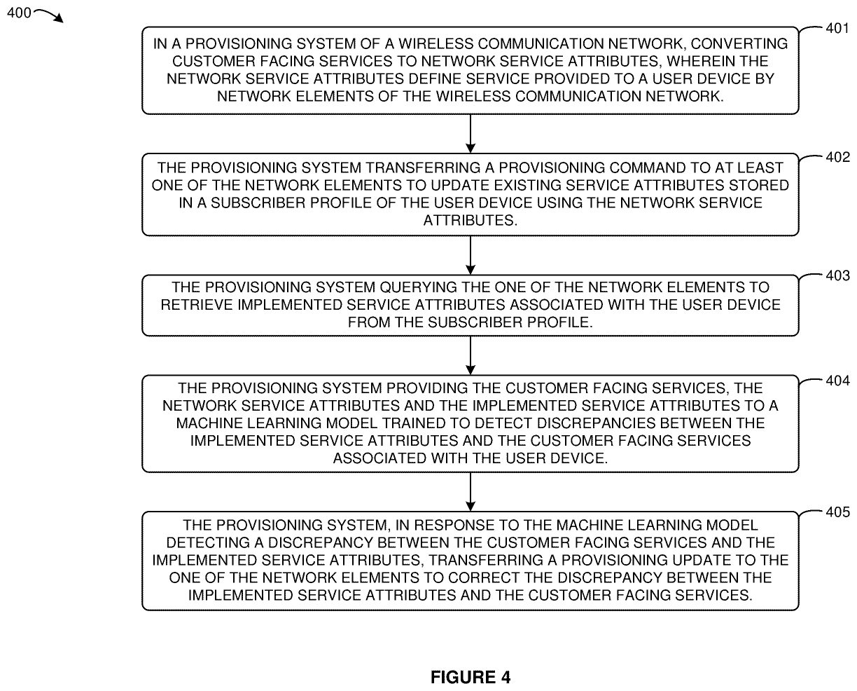

FIG. 4 illustrates process 400. Process 400 comprises an exemplary operation of wireless communication network 300 to detect provisioning anomalies. Process 400 comprises an example of process 200 illustrated in FIG. 2, however process 200 may differ. The operations of process 400 comprise in a provisioning system of a wireless communication network, converting customer facing services to network service attributes, wherein the network service attributes define service provided to a user device by network elements of the wireless communication network (step 401). The operations further comprise the provisioning system transferring a provisioning command to at least one of the network elements to update existing service attributes stored in a subscriber profile of the user device using the network service attributes (step 402). The operations further comprise the provisioning system querying the one of the network elements to retrieve implemented service attributes associated with the user device from the subscriber profile (step 403). The operations further comprise the provisioning system providing the customer facing services, the network service attributes, and the implemented service attributes to a machine learning model trained to detect discrepancies between the implemented service attributes and the customer facing services associated with the user device (step 404). The operations further comprise the provisioning system, in response to the machine learning model detecting a discrepancy between the customer facing services and the implemented service attributes, transferring a provisioning update to the one of the network elements to correct the discrepancy between the implemented service attributes and the customer facing services (step 405).

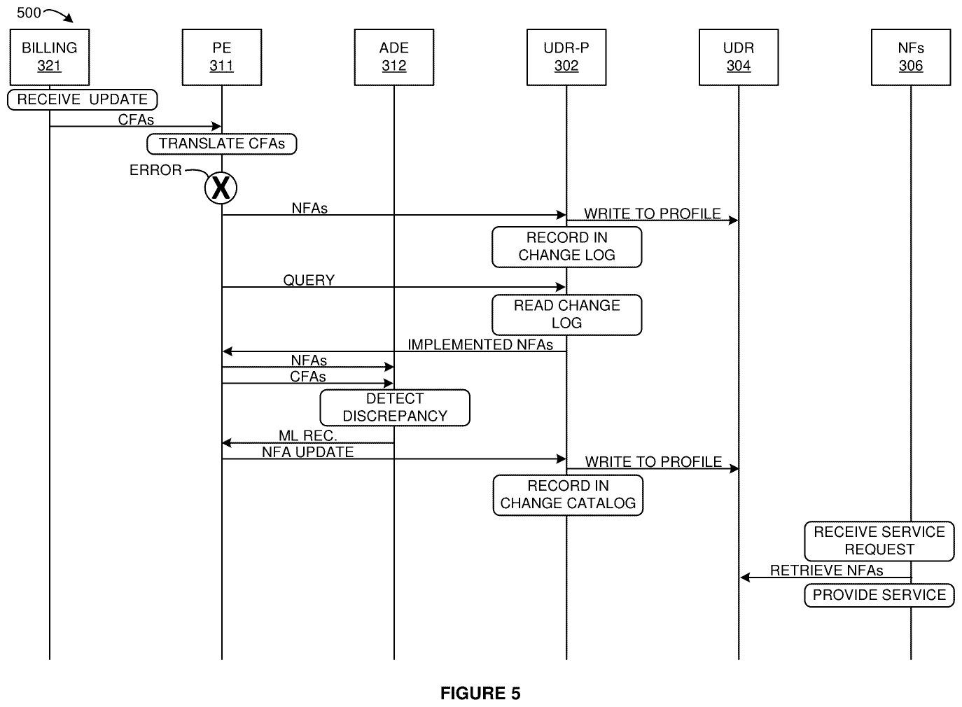

FIG. 5 illustrates process 500. Process 500 comprises an exemplary operation of wireless communication network 300 to detect provisioning anomalies. Process 500 comprises an example of process 200 illustrated in FIG. 2 and process 400 illustrated in FIG. 4, however processes 200 and 400 may differ. In some examples, billing system 321 receives a customer request to update their subscription on network 300. For example, the customer request may comprise a device activation, device deactivation, service addition, service removal, service restoration, and the like. Billing system 321 transfers customer facing attributes (CFAs) characterizing the service request to provisioning engine 311. Provisioning engine 311 translates the customer facing attributes into network facing attributes to enable the subscription change for the customer. A single customer facing attribute typically corresponds to multiple network facing attributes. For example, a group of ten customer facing attributes that define a subscription change may correspond to as many as 5,000-10,000 network facing attributes to enable the subscription change.

Once the customer facing attributes have been translated, provisioning engine 311 generates a provisioning command comprising the translated attributes. The provisioning command identifies the intended one of subscriber profiles 305 by IMSI and directs UDR-P 302 to update the profile using the included network facing attributes. Provisioning engine 311 transfers the provisioning command to UDR-P 302. UDR-P 302 accesses the subscriber profile stored in UDR 304 and updates corresponding ones of the network facing attributes. For example, the provisioning command may include an address value pair to modify authorized QoS and UDR-P 302 may update the existing authorized QoS address value pair with the value pair included in the provisioning command. UDR-P 302 records the changes in change log 303. As provisioning engine 311 generates and transfers the provisioning command, an error occurs causing the network attributes sent to UDR-P 304 to become misaligned with the customer facing attributes received from billing system 321. Example errors include execution errors, runtime errors, translation errors, signaling errors, and the like.

To ensure the user device is being provided with the correct service, provisioning engine 311 queries UDR-P 302 to retrieve data characterizing the updated profile. In particular, provisioning engine 311 transfers a query to determine which network facing attributes were actually loaded to the subscriber profile by UDR-P 302. It should be appreciated that provisioning engine 311 handles hundreds of transactions per second and that this large data volume can cause provisioning errors in the subscriber profiles. For example, provisioning engine 311 may erroneously include network facing attributes for services the user device is not subscribed for and UDR-P 302 may write these network facing attributes to the subscriber profile thereby over-provisioning the user device. Conversely, provisioning engine 311 may erroneously exclude network facing attributes for services the user device is subscribed for and UDR-P 302 may fail to write these network facing attributes to the subscriber profile thereby under-provisioning the user device. Alternatively, provisioning engine 311 may include the network facing attributes but with incorrect address value pairs (e.g., a QoS value lower than what the device is subscribed to), and UDR-P 302 may write the network facing attribute with the erroneous value to the subscriber profile thereby incorrectly provisioning the user device. UDR-P 302 receives the query from provisioning engine 311 and reads change log 302 to determine the network facing attributes that were loaded to the subscriber profile during the update. UDR-P 302 indicates the implemented network facing attributes to provisioning engine 311.

Provisioning engine 311 provides the network facing attributes it transferred in the provisioning command, the implemented attributes retrieved from UDR-P 302, and the customer facing attributes received from billing system 321 to anomaly detection engine (ADE) 312. Detection engine 312 converts the attributes into feature vectors and provides the feature vectors to its machine learning model trained to detect provisioning discrepancies. A feature vector is a numeric representation of data interpretable by a machine learning model. For example, one of the feature vectors may comprise a numeric representation of a customer facing attribute for domestic calling. Detection engine 312 generates a machine learning recommendation that indicates a discrepancy between the attributes loaded to the subscriber profile and the services defined by the customer facing attributes. The output further comprises recommended network facing attributes (and/or other actions) to correct the discrepancy. Detection engine 312 surfaces the machine learning recommendation to provisioning engine 311. For example, the recommendation may indicate the subscriber profile was loaded with an erroneous QoS address value pair (e.g., an erroneous value) and may recommend correcting the erroneous QoS address value pair to match the QoS address value pair that the user is subscribed to.

Provisioning engine 311 transfers a provisioning update comprising the recommended attributes to UDR-P 302. UDR-P 302 accesses the subscriber profile stored in UDR 304 and updates corresponding ones of the network facing attributes to correct the service discrepancy. UDR-P 302 records the changes in change log 303. Subsequently, network functions 306 receive a service request for a user device associated with the updated subscriber profile. Network functions 306 access the subscriber profile stored on UDR 304 and read the network facing attributes stored in the profile. Network functions 306 provide wireless service to the device based on the network facing attributes. By quickly interfacing with anomaly detection engine 312, provisioning engine 311 may detect and remediate provisioning errors before network functions 306 access the subscriber profile to service the user device thereby reducing the likelihood of provisioning-based service interruptions.

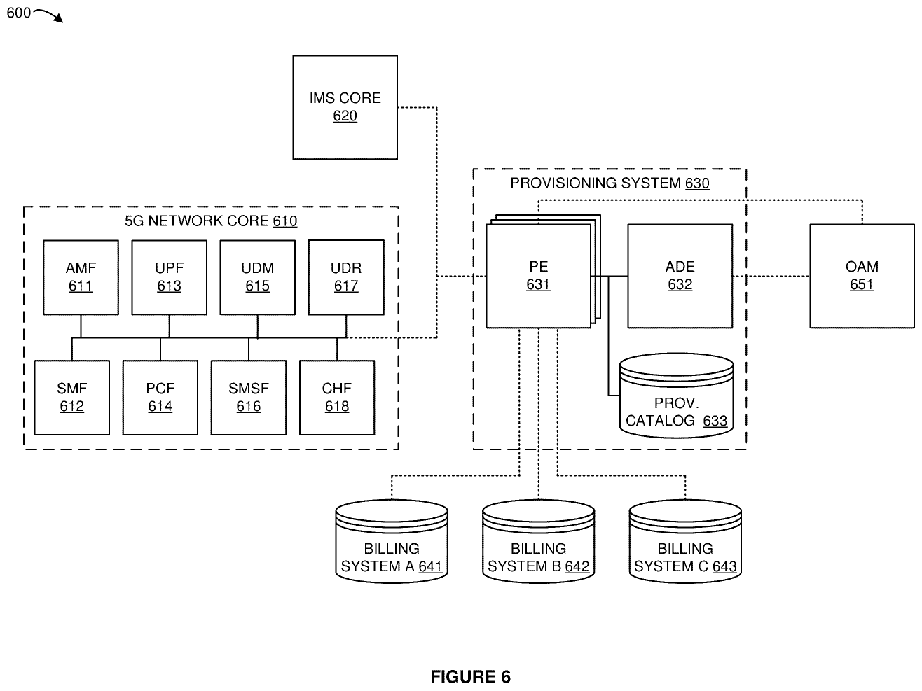

FIG. 6 illustrates 5G communication network 600 to detect provisioning anomalies. 5G communication network 600 comprises an example of communication network 100 illustrated in FIG. 1 and wireless communication network 300 illustrated in FIG. 3, however networks 100 and 300 may differ. 5G communication network 600 comprises 5G network core 610, Internet Protocol Multimedia (IMS) core 620, provisioning system 630, billing systems 641-643, and Orchestration and Management (OAM) 651. Network core 610 comprises Access and Mobility Management Function (AMF) 611, Session Management Function (SMF) 612, User Plane Function (UPF) 613, Policy Control Function (PCF) 614, Unified Data Management (UDM) 615, Short Message Service Function (SMSF) 616, Unified Data Registry (UDR) 617, and Charging Function (CHF) 618. Provisioning system 630 comprises Provisioning Engine (PE) 631, Anomaly Detection Engine (ADE) 632, and provisioning (PROV.) catalog 633. As illustrated in FIG. 6, billing systems 641-643 are labeled A, B, and C respectively. Each billing system is associated with an operator or subscription type on network 600. For example, billing systems 641-643 may be associated with the primary operator of network 600, Mobile Virtual Network Operators (MVNOs) operating on network 600, prepaid subscribers, postpaid subscribers, wholesale subscribers, and the like. Other network functions and network entities like Authentication Server Function (AUSF), Network Slice Selection Function (NSSF), Network Repository Function (NRF), Equipment Identity Register (EIR), Network Exposure Function (NEF), and Application Function (AF) are typically present in 5G network core 610, IMS core 620, and/or provisioning system 630 but are omitted for clarity. While illustrated as a 5G network, in other examples network 600 may comprise another type of 3GPP network like a 6G network, LTE network, or combination thereof. In other examples, 5G communication network 600 may comprise different or additional elements than those illustrated in FIG. 6.

In some examples, one of billings systems 641-643 detects a subscription modification event for a subscriber in network 600. The event detection may be automated (e.g., service shutoff in response to unpaid bill) or in response to a customer request (e.g., customer requested service modification and/or service addition). The billing system transfers a subscription modification request to provisioning system 630 based on the billing event. The subscription modification request identifies the brand (e.g., primary operator or MVNO) and subscription type (e.g., prepaid) that the billing system is associated with. The modification request includes codes that indicate the subscription modification type (referred to as the transaction) and the customer service(s) (referred to as Customer Facing Specification (CFS)) that is to be modified. The request also includes a subscriber identity code like IMSI or SUPI. Exemplary transaction types include activation, deactivation, port-in, port-out, update customer profile, update feature, suspension, restore, change MSISDN, change SIM, change bill cycle, BAN to BAN change, add/deduct balance, voicemail PIN reset, line re-provisioning, and the like. Exemplary CFSs include voice, international voice, international/domestic roaming, call forwarding, call waiting capability, SMS, MMS, RCS, domestic data service, hotspot capability, roaming data service, voicemail, static IP management, WiFi calling, scam protection, value added service, and the like. For example, billing system A 641 may transfer a subscription modification request that indicates it is associated with an MVNO for prepaid service, includes a code for an activation transaction and a CFS for hotspot capability, and identifies a subscriber by IMSI.

PE 631 comprises a number of instances that are each associated with one of billing systems 641-643 based on the brand and/or service type of the billing system. For example, a first instance of provisioning system 631 may be associated with billing system A 641 while a second instance of providing system 631 may be associated with billing system B 641. Provisioning system 630 receives the modification request from the billing system the detected the billing event. Provisioning system 630 routes the request to the instance of PE 631 associated with the brand and/or service type of the billing system. PE 631 accesses provisioning catalog 633 to translate the transaction type and CFS for the brand/service type into a network node type(s) (referred to as Resource Facing Specification (RFS)) and address value pair(s) (referred to as Logical Resource Specification (LRS)). The RFS defines the network functions/entities in 5G core 610 and/or IMS core 620 where the transaction is to occur. The LRS defines the service attributes in the RFS that are to be updated. For example, PE 631 may transfer a translation request including an update customer profile transaction and CFS for Quality-of-Service Class Indicator (QCI) increase to catalog 633. In response, catalog 633 may return RFSs for PCF 614 and UDR 617 and LRSs to increase QCI.

PE 631 generates a provisioning update that includes the LRSs retrieved from provisioning catalog 633 and identifies the subscriber by IMSI. PE 631 transfers the update to network functions/entities in cores 610 and 620 based on the RFSs retrieved from catalog 633. For example, if the RFS identifies CHF 618, PE 631 transfers the update to CHF 618. PE 631 logs the update in a change log maintained by catalog 633. The log event indicates the transaction type, CFS, RFS, LRS, time-stamp, update ID, and/or other data characterizing of the provisioning update.

To ensure the update was successfully implemented and inhibit desynchronization between billing systems 641-643 and cores 610 and 620, PE 631 queries the network functions/entities that received the update to determine LRSs that were actually implemented by the network functions/entities. For example, if the RFS of the update indicated UDR 617 and the corresponding LRS updated mobility policies in a subscriber profile, PE 631 may query UDR 617 to determine the active mobility policies in the subscriber profile.

ADE 632 comprises a machine learning model trained to detect anomalies in provisioning operations conducted by PE 631. The machine learning model comprise any machine learning model or artificial intelligence system implemented within network 600 trained to detect discrepancies between requested customer services and provisioned services, execution anomalies in PE 631, update writing anomalies in cores 610 and 620, and/or other types of provisioning errors. A machine learning model comprises one or more artificial intelligence/machine learning algorithms that are trained based on historical data and/or other types of training data associated with wireless communication networks. A machine learning model may employ one or more machine learning algorithms through which data can be analyzed to identify patterns, make decisions, make predictions, or similarly produce output. Examples of machine learning algorithms that may be employed solely or in conjunction with one another include Large Language Models (LLMs), Three Dimensional (3D) deep leaning models, 3D convolutional neural networks, times series convolutional deep learning, transformers, multi-layer perceptron, long term short memory, and attention based deep learning model. Other exemplary machine learning algorithms include artificial neural networks, nearest neighbor methods, ensemble random forests, support vector machines, naïve Bayes methods, linear regressions, or similar machine learning techniques or combinations thereof capable of predicting output based on input data.

Once the implemented service attributes are retrieved, PE 631 transfers an anomaly detection request to ADE 632. The request includes the retrieved service attributes as well as a time-stamp (or another type of lookup information) for the update. ADE 632 accesses provisioning catalog 633 to retrieve the transaction type(s), CFS(s), RFS(s), and LRS(s) of the update based on the time-stamp of the update. ADE 632 converts the implemented LRS(s) retrieved by PE 631, and the transaction type(s), CFS(s), RFS(s), and LRS(s) retrieved from catalog 633. ADE 632 provides the feature vectors to its machine learning algorithms to generate a machine learning output. The machine learning output comprises data characterizing any detected anomalies and when an anomaly is detected, a recommended actions to remediate the anomaly. Exemplary anomaly types include erroneously excluded LRSs (e.g., under-provisioning), erroneously included LRSs (e.g., over-provisioning), incorrect LRS values, and the like. For example, the machine learning output may indicate the maximum data rate LRS loaded to the subscriber profile differs from the user's subscriber data rate (e.g., an incorrect LRS value). Exemplary recommended actions included transferring provisioning updates to a network function/node to include an absent LRS, remove an unauthorized LRS, and/or adjust an existing LRS to a correct value. When the machine learning model does not detect an anomaly, ADE 632 notifies PE 631 that the provisioning update was successful. When the machine learning model detects an anomaly, ADE 632 indicates the detected anomaly and recommended remediation action to PE 631. For example, the machine learning model in ADE 632 may generate an output that indicates the LRS for voice calling authorization was erroneously excluded from a subscriber profile stored in UDR 617 during the provisioning update. The output may further recommend adding the LRS for voice calling authorization to the subscriber profile.

When PE 631 is notified of an anomaly, PE 631 generates a new provisioning update based on the action recommended by the machine learning engine. The new provisioning update includes the LRSs and/or a command to remove LRSs and identifies the subscriber by IMSI. PE 631 transfers the update to network functions/entities in cores 610 and 620 based on RFSs recommended by the model. The receiving network functions/entities implement the new provisioning update. PE 631 logs the update in the change log. Contemporaneously, ADE 321 notifies OAM 631 of the anomaly and recommended action to alert network operators. The network operators may diagnose the cause of the anomaly (e.g., execution issues in PE 631, writing issues in core 610, etc.) based on the machine learning output. The network operators may then take actions to correct the cause of the anomaly and determine if the cause anomaly is occurring in other network locations (e.g., other instances of PE 631). Alternatively, the anomaly diagnostics process may be automated. For example, the machine learning model of ADE 632 may be further trained to diagnose the cause of the anomalies.

Subsequent to the update, AMF 611 receives a service request from a User Equipment (UE) of the subscriber associated with the provisioning update. AMF 611 interfaces with the other network functions in core 610 to authenticate and authorize the UE for wireless service. In response to authentication and authorization, AMF 611 retrieves service attributes and network policies from the other network functions. The retrieved attributes and network policies include the LRSs updated/corrected by provisioning system 630. AMF 611 generates context for the UE based on the retrieved attributes and network policies and directs SMF 612 to establish a data session for the UE based on the context. SMF 612 controls UPF 613 to serve the UE over a Radio Access Network (RAN).

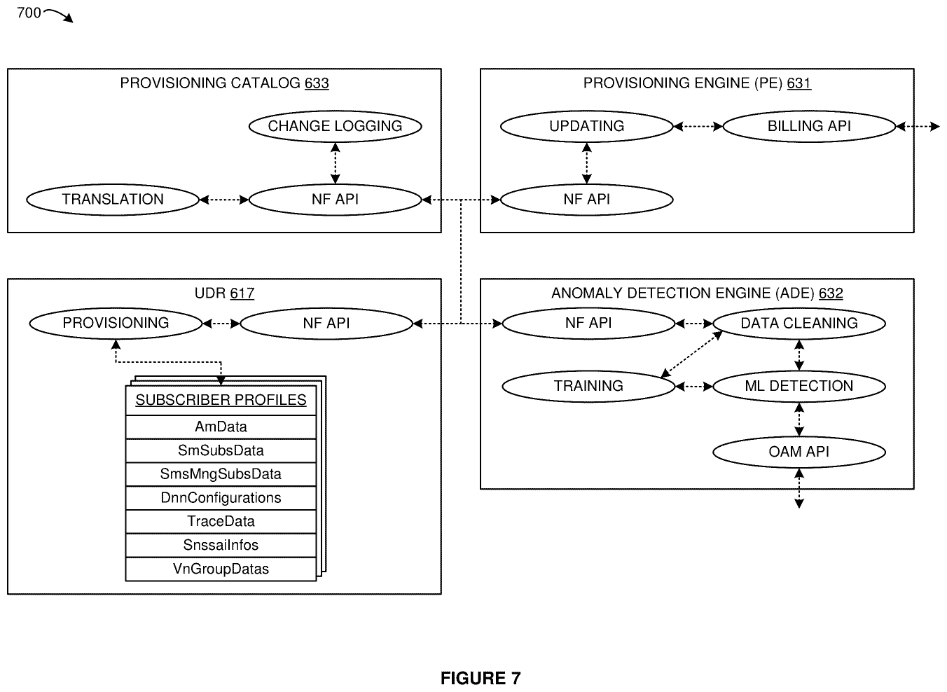

FIG. 7 illustrates the provisioning relationship between UDR 617 in core 610 and PE 631, ADE 632, and provisioning catalog 633 of provisioning system 630. The provisioning relationship between provisioning system 630 and the other network functions and network entities in cores 610 and 620 like PCF 614, UDM 615, SMSF 616, and CHF 618 is similar. UDR 617 comprises modules for provisioning control and network function API and stores subscriber profiles. The provisioning control module implements updates on the subscriber profiles in response to direction from the updating module in PE 631. The subscriber profile comprises service attributes like access and mobility data (AmData), session management subscription data (SmSubsData), SMS management subscription data (SmsMngSubsData), DNN configurations (DnnConfigurations), Trace Data (TraceData), S-NSSAI information (SnssaiInfos), and virtual network group data (VnGroupDatas). Each subscriber profile corresponds to an IMSI of a user device. The service attributes comprise LRS values that define the level of service for user device and often differ from profile to profile. For example, an LRS may enable a set of DNN configurations in one of the subscriber profiles. It should be appreciated that these service attributes are exemplary and may differ in other examples.

PE 631 comprises modules for subscription updating, network function API, and billing system API. The subscription updating module processes subscription modification requests received from billing systems 641-643 and writes provisioning updates to subscriber profiles stored by UDR 617. It should be appreciated that the updating module may also transfer provisioning updates to the other functions in network 600. The subscription updating module interfaces with ADE 632 to detect provisioning errors and implement machine learning recommendations.

ADE 632 comprises modules for network function API, data cleaning, machine learning model training, machine learning anomaly detection, and OAM API. The data cleaning module filters data received from PE 631 and the change log maintained by catalog 633 for the machine learning model. The training module trains the machine learning model based on CFS, RFS, and LRS relationships maintained by catalog 633. In particular, the training model forms training data sets to train the machine learning algorithms to correlate available CFSs on network 600 with corresponding RFSs and LRSs. The training process may be a supervised or unsupervised machine learning process. The model training process may continue after the model is pushed to production to continuously advance the model's algorithms and to account for service changes on network 600. The machine learning detection module detects provisioning discrepancies between CFSs received from the billing system and LRSs loaded to UDR 617 during the subscriber update. The machine learning detection module recommends actions to PE 631 to correct detected anomalies. The machine learning detection module notifies network operators of the detected anomalies via the OAM API.

Provisioning catalog 633 comprises modules for network function API, change logging, and CFS/RFS/LRS translation. The change logging module records provisioning updates implemented by PE 631 with data like CFS, RFS, LRS, time-stamp, update ID, and/or other data characterizing the update. The translation module converts CFSs and transaction types to RFSs and LRSs based on the billing system service type/brand associated with the update. The APIs allow PE 631, ADE 632, catalog 633, and UDR 617 to exchange signaling with each other, the other network functions/entities in 5G core 610 and IMC core 620, and external systems like billing systems 641-643.

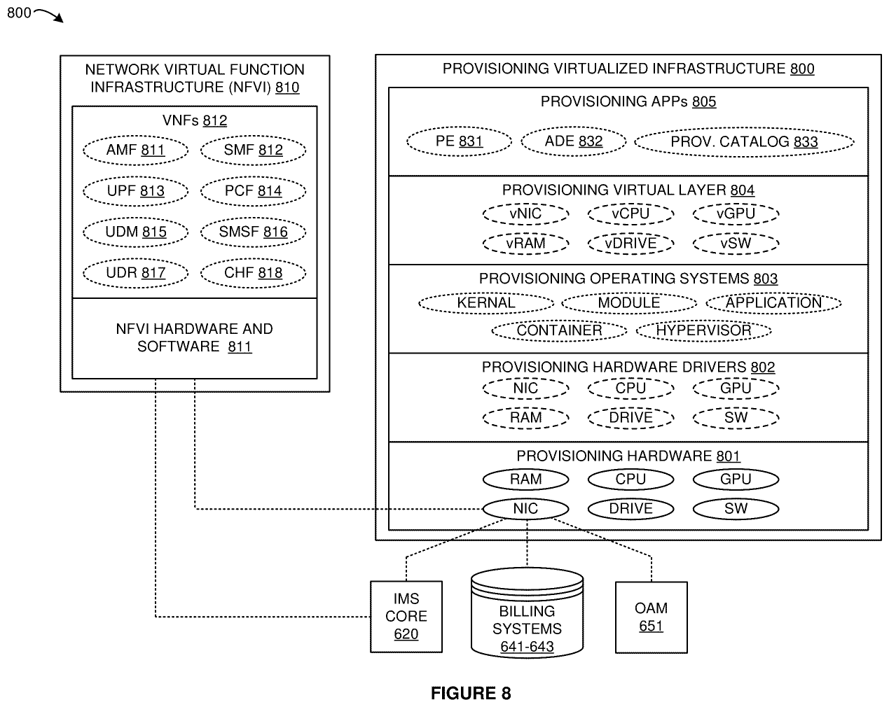

FIG. 8 illustrates provisioning virtualized infrastructure 800 and Network Function Virtualization Infrastructure (NFVI) 810 in 5G wireless communication network 600. Provisioning virtualized infrastructure 800 comprises an example provisioning controller 123 illustrated in FIG. 1 and provisioning system 310 illustrated in FIG. 3, however controller 123 and system 310 may differ. NFVI 810 comprises an example of network elements 124 illustrated in FIG. 1 and network elements 301 illustrated in FIG. 3, however network elements 124 and network elements 301 may differ.

Provisioning virtualized infrastructure 800 comprises provisioning hardware 801, provisioning hardware drivers 802, provisioning operating systems 803, provisioning virtual layer 804, and provisioning applications (APPs) 805. Provisioning hardware 801 comprises Network Interface Cards (NICs), CPU, GPU, RAM, Flash/Disk Drives (DRIVE), and Data Switches (SW). Provisioning hardware drivers 802 comprise software that is resident in the NIC, CPU, GPU, RAM, DRIVE, and SW. Provisioning operating systems 803 comprise kernels, modules, applications, containers, hypervisors, and the like. Provisioning virtual layer 804 comprises vNIC, vCPU, vGPU, vRAM, vDRIVE, and vSW. Provisioning applications 805 comprise PE 831, ADE 832, and provisioning catalog 833. Additional provisioning applications are typically present but are omitted for clarity. In some examples, provisioning virtualized infrastructure 800 utilizes a container-based orchestration system like Kubernetes.

NFVI 810 comprises NFVI hardware and software 811 and Virtual Network Functions (VNFs) 812. NFVI hardware and software 811 comprises NFVI hardware, NFVI hardware drivers, NFVI operating systems, and an NFVI virtual layer. The NFVI hardware comprises NICs, CPU, RAM, flash/disk drives, and data switches. The NFVI hardware drivers comprise software that is resident in the NIC, CPU, RAM, flash/disk drives, and data switches. The NFVI operating systems comprise kernels, modules, applications, containers, hypervisors, and the like. The NFVI virtual layer comprises vNIC, vCPU, vRAM, virtual flash/disk drives, and virtual data switches. VNFs 812 comprise AMF 811, SMF 812, UPF 813, PCF 814, UDM 815, SMSF 616, UDR 817, and CHF 818. Additional VNFs and network elements like AUSF, NSSF, NRF, EIR, NEF, and AF are typically present but are omitted for clarity.

Provisioning virtualized infrastructure 800 and NFVI 810 may be located at a single site or be distributed across multiple geographic locations. The NIC in provisioning hardware 801 is coupled to a NIC in NFVI hardware and software 811, to IMS core 620, billing systems 641-643, and OAM 651. The NIC in NFVI hardware and software 811 is coupled to the NIC in provisioning hardware 801 and to IMS core 620. Provisioning hardware 801 executes provisioning hardware drivers 802, provisioning operating systems 803, provisioning virtual layer 804, and provisioning applications 805 to form PE 631, ADE 632, and provisioning catalog 633. The NFVI hardware in NFVI hardware and software 811 executes the NFVI hardware drivers, NFVI operating systems, NFVI virtual layer, and VNFs 812 to form AMF 611, SMF 612, UPF 613, PCF 614, UDM 615, SMSF 616, UDR 617, and CHF 618.

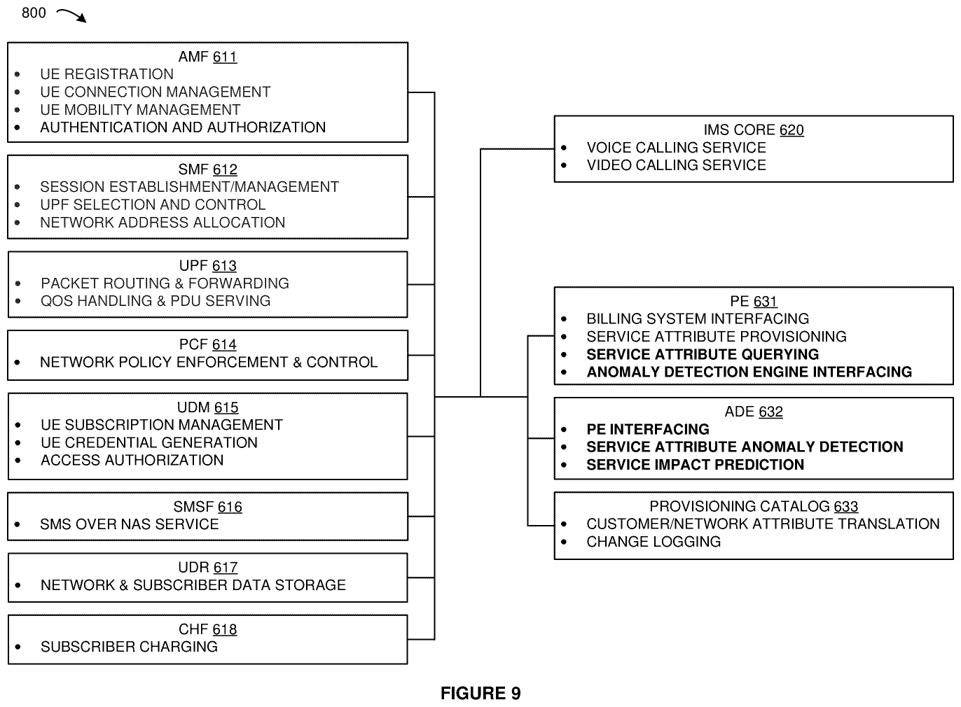

FIG. 9 further illustrates provisioning virtualized infrastructure 800, NFVI 810, and IMS core 620 in 5G communication network 600. AMF 611 comprises capabilities for UE registration, UE connection management, UE mobility management, and UE authentication and authorization. SMF 612 comprises capabilities for session establishment and management, UPF selection and control, and network address allocation. UPF 613 comprises capabilities for packet routing and forwarding, QoS handling, and PDU serving. PCF 614 comprises capabilities for network policy enforcement and network policy control. UDM 615 comprises capabilities for UE subscription management, UE credential generation, and UE access authorization. SMSF 616 comprises capabilities for SMS over Non-Access Stratum (NAS) service. UDR 617 comprises capabilities for network and subscriber data storage. CHF 618 comprises capabilities for subscriber charging. IMS core 620 comprises capabilities for voice calling service and video calling service. PE 631 comprises capabilities for billing system interfacing, service attribute provisioning, service attribute querying, and anomaly detection engine interfacing. ADE 632 comprises capabilities for provisioning engine interfacing, service attribute anomaly detection, and service impact prediction. Provisioning catalog 633 comprises capabilities for customer/network attribute translation and change logging.

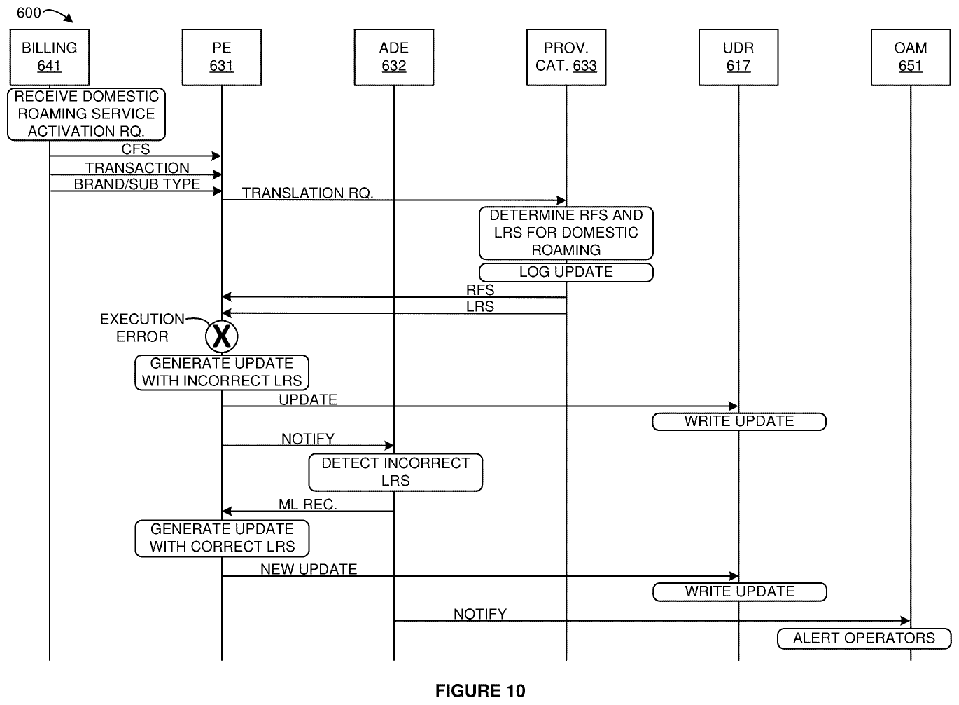

FIG. 10 illustrates an exemplary operation of 5G communication network 600 to detect provisioning anomalies. The operation may vary in other examples. In some examples, billing system A 641 receives a subscription update request to enable domestic roaming for a subscriber. Billing system 641 transfers the CFS for domestic roaming, an activate transaction request, the brand/subscription type indication for system 641, and the IMSI indicating the subscriber to PE 631. PE 631 transfers a translation request (RQ.) to provisioning catalog (PROV. CAT.) 633. Provisioning catalog 633 determines the RFS for UDR 617 and the LRS for domestic roaming based on the CFS, transaction type, and brand/subscription type of billing system 641. Provisioning catalog 633 logs the CFS, transaction type, RFS, and LRS for the update. Provisioning catalog 633 indicates the RFS and LRS to PE 631. When generating the provisioning update, an execution error occurs causing PE 631 to generate a provisioning update with the incorrect LRS. PE 631 transfers the provisioning update with the incorrect LRS to UDR 617. UDR 617 loads a subscriber profile that corresponds to the IMSI for the subscriber with the incorrect LRS. PE 631 notifies ADE 632 of the update. ADE 632 retrieves logged data characterizing the update from catalog 633. ADE 632 processes the retrieved log data using its machine learning model and detects PE 631 loaded the UDR 617 with an incorrect LRS. ADE 632 transfers a machine learning recommendation to PE 631. In response, PE 631 generates a new provisioning update with the correct LRS for domestic roaming and a command to remove the incorrect LRS. PE 631 transfers the new update to UDR 617. UDR 617 loads the subscriber profile that corresponds to IMSI for the subscriber with the LRS for domestic roaming and removes the incorrect LRS included by the original update to correct the discrepancy. ADE 632 notifies OAM 651 of the detected anomaly. OAM 651 surfaces the anomaly to network operators to diagnose the issue that caused the provisioning error. While the above example is given in the context of a CFS for domestic roaming and activation transaction, it should be appreciated that the above operation may be used for other CFSs and other transaction types.

The wireless data network circuitry described above comprises computer hardware and software that form special-purpose network circuitry to detect provisioning anomalies. The computer hardware comprises processing circuitry like CPUs, DSPs, GPUs, transceivers, bus circuitry, and memory. To form these computer hardware structures, semiconductors like silicon or germanium are positively and negatively doped to form transistors. The doping comprises ions like boron or phosphorus that are embedded within the semiconductor material. The transistors and other electronic structures like capacitors and resistors are arranged and metallically connected within the semiconductor to form devices like logic circuitry and storage registers. The logic circuitry and storage registers are arranged to form larger structures like control units, logic units, and Random-Access Memory (RAM). In turn, the control units, logic units, and RAM are metallically connected to form CPUs, DSPs, GPUs, transceivers, bus circuitry, and memory.

In the computer hardware, the control units drive data between the RAM and the logic units, and the logic units operate on the data. The control units also drive interactions with external memory like flash drives, disk drives, and the like. The computer hardware executes machine-level software to control and move data by driving machine-level inputs like voltages and currents to the control units, logic units, and RAM. The machine-level software is typically compiled from higher-level software programs. The higher-level software programs comprise operating systems, utilities, user applications, and the like. Both the higher-level software programs and their compiled machine-level software are stored in memory and retrieved for compilation and execution. On power-up, the computer hardware automatically executes physically-embedded machine-level software that drives the compilation and execution of the other computer software components which then assert control. Due to this automated execution, the presence of the higher-level software in memory physically changes the structure of the computer hardware machines into special-purpose network circuitry to detect provisioning anomalies.

The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. Thus, the invention is not limited to the specific embodiments described above, but only by the following claims and their equivalents.

What is claimed is:

1. A method comprising:
in a provisioning system of a wireless communication network, converting customer facing services to network service attributes, wherein the network service attributes define service provided to a user device by network elements of the wireless communication network;
the provisioning system transferring a provisioning command to at least one of the network elements to update existing service attributes stored in a subscriber profile of the user device using the network service attributes;
the provisioning system querying the one of the network elements to retrieve implemented service attributes associated with the user device from the subscriber profile;
the provisioning system providing the customer facing services, the network service attributes, and the implemented service attributes to a machine learning model trained to detect discrepancies between the implemented service attributes and the customer facing services associated with the user device; and
the provisioning system, in response to the machine learning model detecting a discrepancy between the customer facing services and the implemented service attributes, transferring a provisioning update to the one of the network elements to correct the discrepancy between the implemented service attributes and the customer facing services.

2. The method of claim 1 wherein the provisioning system transferring the provisioning update to the one of the network elements to correct the discrepancy comprises loading the subscriber profile with ones of the network service attributes that were not included by the provisioning command.

3. The method of claim 1 wherein the provisioning system transferring the provisioning update to the one of the network elements to correct the discrepancy comprises removing ones of the implemented service attributes that were erroneously included in the subscriber profile by the provisioning command.

4. The method of claim 1 wherein the provisioning system transferring the provisioning update to the one of the network elements to correct the discrepancy comprises correcting an erroneous value in the implemented service attributes.

5. The method of claim 1 wherein the provisioning system converting the customer facing services to the network service attributes comprises receiving the customer facing services from a network billing system and interfacing with a network provisioning catalog to translate the customer facing services to the network service attributes.

6. The method of claim 1 further comprising the provisioning system obtaining a machine learning output that comprises data indicating the discrepancy and a recommended action to correct the discrepancy.

7. The method of claim 1 further comprising:
the provisioning system training the machine model to detect the discrepancies between the implemented service attributes and the network service attributes based on training data; and wherein:
the training data comprises available customer facing services and available network service attributes.

8. The method of claim 1 wherein the one of the network elements comprises a Unified Data Registry (UDR) of the wireless communication network.

9. The method of claim 1 wherein the wireless communication network comprises a Third Generation Partnership Project (3GPP) communication network.

10. A wireless communication network comprising:
network provisioning circuitry to:
convert customer facing services to network service attributes, wherein the network service attributes define service provided to a user device by network elements of the wireless communication network;
transfer a provisioning command to at least one of the network elements to update existing service attributes stored in a subscriber profile of the user device using the network service attributes;
query the one of the network elements to retrieve implemented service attributes associated with the user device from the subscriber profile;
provide the customer facing services, the network service attributes, and the implemented service attributes to a machine learning model trained to detect discrepancies between the implemented service attributes and the customer facing services associated with the user device;
in response to the machine learning model detecting a discrepancy between the customer facing services and the implemented service attributes, transfer a provisioning update to the one of the network elements to correct the discrepancy between the implemented service attributes and the customer facing services.

11. The wireless communication network of claim 10 wherein the network provisioning circuitry is to load the subscriber profile with ones of the network service attributes that were not included by the provisioning command.

12. The wireless communication network of claim 10 wherein the network provisioning circuitry is to remove ones of the implemented service attributes that were erroneously included in the subscriber profile by the provisioning command.

13. The wireless communication network of claim 10 wherein the network provisioning circuitry is to correct an erroneous value in the implemented service attributes.

14. The wireless communication network of claim 10 wherein the network provisioning circuitry is to receive the customer facing services from a network billing system and interface with a network provisioning catalog to translate the customer facing services to the network service attributes.

15. The wireless communication network of claim 10 wherein the network provisioning circuitry is to obtain a machine learning output that comprises data indicating the discrepancy and a recommended action to correct the discrepancy.

16. The wireless communication network of claim 10 wherein the network provisioning circuitry is to train the machine model to detect the discrepancies between the implemented service attributes and the network service attributes based on training data; and wherein:
the training data comprises available customer facing services and available network service attributes.

17. The wireless communication network of claim 10 wherein the one of the network elements comprises a Unified Data Registry (UDR) of the wireless communication network.

18. The wireless communication network of claim 10 wherein the wireless communication network comprises a Third Generation Partnership Project (3GPP) communication network.

19. One of more non-transitory computer readable storage media having program instructions stored thereon, wherein the program instruction, when executed by a computing system, direct the computing system to perform operations, the operations comprising:
in a provisioning system of a wireless communication network, converting customer facing services to network service attributes, wherein the network service attributes define service provided to a user device by network elements of the wireless communication network;
transferring a provisioning command to at least one of the network elements to update existing service attributes stored in a subscriber profile of the user device using the network service attributes;
querying the one of the network elements to retrieve implemented service attributes associated with the user device from the subscriber profile;
providing the customer facing services, the network service attributes, and the implemented service attributes to a machine learning model trained to detect discrepancies between the implemented service attributes and the customer facing services associated with the user device; and
in response to the machine learning model detecting a discrepancy between the customer facing services and the implemented service attributes, transferring a provisioning update to the one of the network elements to correct the discrepancy between the implemented service attributes and the customer facing services.

20. The computer readable storage media of claim 15 wherein transferring the provisioning update to the network data system to correct the discrepancy comprises one or more of:
loading the subscriber profile with ones of the network service attributes that were not included by the provisioning command,
removing ones of the implemented service attributes that were erroneously included in the subscriber profile by the provisioning command, or
correcting an erroneous value in the implemented service attributes.
